(19) United States
(12) Patent Application Publication
(10) Pub. No.: US 2004/0021375 A1
(43) Pub. Date: Feb. 5, 2004

(54) Stepping motor and manufacturing method therefor

(75) Inventor: Eiji Mayumi, Nagano (JP)

Correspondence Address: HOGAN & HARTSON L.L.P., 500 S. GRAND AVENUE, SUITE 1900, LOS ANGELES, CA, 90071-2611, US

(73) Assignee: SANKYO SEIKI MFG. CO., LTD.

(21) Appl. No.: 10/606,198

(22) Filed: Jun. 24, 2003

(30) Foreign Application Priority Data
Jul. 25, 2002 (JP) 2002-217191
Jan. 30, 2003 (JP) 2003-021635

(51) Int. Cl. H02K 37/00

(52) U.S. Cl. 310/49 R; 310/71; 310/45; 310/257

(57) ABSTRACT

A stepping motor includes a ring-shaped stator core having a plurality of pole teeth erected from an inner circumferential edge portion, a coil winding wound around the pole teeth and a terminal pin part to which a terminal end of the coil winding is wound around. The terminal pin part is integrally formed and extended from the stator core and an entire surface of at least the terminal pin part of the stator core is covered with an insulating layer.

### BACKGROUND OF THE INVENTION

1. Field of the Invention

The present invention relates to a stepping motor and a manufacturing method for a stepping motor.

2. Description of Related Art

A conventional small-sized stepping motor generally includes a rotor 2, a stator 6A opposed to the rotor 2, a ring-shaped coil bobbin 10, and coil windings 3 wound around a cylindrical body portion of the coil bobbin 10 as shown in FIG. 5. The coil bobbin 10 is formed by insert molding with inside stator cores 7A constituting the stator 6A. Outside stator cores 8A are fitted to the inside stator cores 7A from both sides to constitute the stator 6A. A terminal part 11 holding a plurality of terminal pins 9 is integrally formed with the coil bobbin 10.

A coil winding part 12 is formed in the cylindrical body portion of the coil bobbin 10 by forming a resin portion circumferentially around on a pole teeth 70A at the time of insert molding. A terminal end 30 of the coil winding 3 which is wound around the coil winding part 12 is wound around the terminal pin 9.

A conventional method for manufacturing a stator 6A of a stepping motor 1A of such a structure includes, as shown in FIG. 6, forming inside stator cores 7A and terminal pins 9 respectively, then forming a coil bobbin 10 by insert-molding with the inside stator cores 7A and the terminal pins 9 together in a step ST 51, winding a coil wire around the coil bobbin 10 to form a coil winding 3 in a step ST 52, and then winding the terminal end 30 of the coil winding 3 around the terminal pin 9.

Also, another conventional method for manufacturing a stator 6A includes forming inside stator cores 7A and terminal pins 9 respectively, then forming a coil bobbin 10 by insert-molding with the inside stator cores 7A in a step ST 61, press-fitting the terminal pins 9 into the coil bobbin 10 in a step ST 62, winding a coil wire around the coil bobbin 10 to form a coil winding 3 in a step ST 52, and then winding the terminal end 30 of the coil winding 3 around the terminal pin 9.

As shown in FIG. 7, a further conventional method for manufacturing a stator 6A includes forming two coil bobbins 10 to which terminal pins 9 are press-fitted or integrally molded, and forming inside stator cores 7A respectively, winding a coil wire around the coil bobbin 10 to form a coil winding 3 in a step ST 71, winding the terminal end 30 of the coil winding 3 around the terminal pin 9, and then attaching the inside stator cores 7A to the respective coil bobbins 10 in a step ST 72.

However, in the conventional methods for manufacturing a stator, when either method for the terminal pin 9 of insert-molding with or press-fitting to the coil bobbin 10 is employed, it is required to ensure the holding strength of the terminal pin 9 by embedding a root portion of the terminal pin 9 into the resin with a prescribed dimension. Therefore, the terminal part 11 of the coil bobbin 10 is required to be formed thick and protruded in a radial direction, and thus a stepping motor 1A cannot be miniaturized.

Besides, a thick resin portion is formed by insert molding as the coil winding part 12, where the coil winding 3 is wound around. Therefore, the thickness of the resin portion prevents the miniaturization of the stepping motor 1A. In other words, it is difficult to make the thickness of the resin portion less than 0.1 mm by insert molding even when the thickness is trying to be reduced.

On the other hand, a stepping motor has been proposed, in which an iron plate formed with an insulating layer thereon is subjected to a press-working to form stator cores and a coil wire is directly wound around a pole teeth of the stator core to form a coil winding. Another stepping motor has been also proposed, in which a conductive pattern is formed on a stator core and soldered with a terminal end of a coil winding.

However, in the above-mentioned stepping motor, when the terminal end of the coil winding is soldered with the conductive pattern on the stator core, the coil wire of the coil winding is apt to be cut and thus work efficiency is lowered. When the diameter of the wire of the coil winding becomes thinner, the problem becomes more outstanding. Also, in the stator core produced by press working of an iron plate on which an insulating layer is formed beforehand, a metal surface is exposed on side edge faces of the pole teeth of the stator core. Therefore, a coil winding is apt to be short-circuited through the stator core even when a self-welding wire is used as the coil winding.

It is conceivable that a separate terminal block provided with terminal pins is prepared to a coil bobbin beforehand and the terminal end of a coil winding is wound around the terminal pin. However, in such a structure, even if a motor is miniaturized, it is necessary to fit the relatively larger terminal block to the motor and thus the miniaturization of the motor by itself has no longer any significance.

### SUMMARY OF THE INVENTION

In view of the problems described above, it is advantage of the present invention to provide a stepping motor and a manufacturing method for a stepping motor, capable of preventing problems such as disconnection or short-circuit of a coil winding even if a coil bobbin is not used.

Further, it is advantage of the present invention to provide a stepping motor and a manufacturing method for a stepping motor, capable of preventing the end portion of a coil winding from slipping off from the tip end of a terminal pin when the wire of the coil winding is wound around the terminal pin.

In accordance with an embodiment of the present invention, there is provided a stepping motor including a ring-shaped stator core having a plurality of pole teeth erected from an inner circumferential edge portion, a coil winding wound around the pole teeth, and a terminal pin to which a terminal end of the coil winding is wound around. A terminal pin part is integrally formed and extended from the stator core as the terminal pin on an outer circumferential edge of the stator core, and an entire surface of at least the terminal pin part of the stator core is covered with an insulating layer.

According to such a stepping motor, since the terminal pin part is integrally formed with the stator core, a coil bobbin for holding a terminal pin is not needed. Accordingly, the size of the stepping motor can be reduced. Also, since the surface of the terminal pin part is covered with the insulating layer, the terminal end of the coil winding is not short-circuited through the terminal pin part. Further, since the terminal pin part is integrally formed with the stator core, the terminal pin part is firmly held to the stator core. Furthermore, since the terminal end of the coil winding is wound around the terminal pin part, the wire of the coil winding is not easily cut, which is different from the conventional case of soldering the terminal end of the coil winding on an electrode pattern formed on the inside stator core. Accordingly, the terminal end of the coil winding can be efficiently handled and treated.

In accordance with an embodiment of the present invention, there is provided a manufacturing method for a stepping motor including a stator core forming step for forming a stator core and a terminal pin part integrally formed with the stator core on an outer edge part of the stator core, a covering step for covering the entire surface of at least the terminal pin part of the stator core with an insulating layer, and a coil mounting step for forming a coil winding around the pole teeth of the stator core and winding a terminal end of the coil winding around the terminal pin part.

According to such a manufacturing method for a stepping motor, the terminal pin part is integrally formed with the stator core at the outer edge part of the stator core and then the insulating layer is formed on the terminal pin part. Therefore, the entire surface of the terminal pin part is coated with the insulating layer, which is different from an imaginative case that a magnetic plate formed with an insulating layer beforehand is punched by press working to form the terminal pin part. Also, since the insulating layer is formed after the terminal pin part along with the stator core, even though a burr is formed by means of press working, the burr can be covered over by the insulating layer. Accordingly, the coil winding is not short-circuited through the terminal pin part 71.

Preferably, the insulating layer is formed on at least the outside surface of the pole teeth of the stator core and the coil winding is directly wound on the insulating layer around the pole teeth. In other words, in the manufacturing method for a stepping motor in accordance with an embodiment of the present invention, it is preferable that at least the outside surface of the pole teeth of the stator core is covered with the insulating layer in the covering step, and in the coil mounting step the coil winding is directly wound on the insulating layer around the pole teeth. According to the manufacturing method for a stepping motor, since a coil bobbin for mounting the coil winding can be eliminated, the stepping motor can be miniaturized. Also, since the coil winding is directly wound around the pole teeth of the stator core, a thick resin portion is not present between the coil winding and the pole teeth, and thus high magnetic efficiency can be obtained. Furthermore, since the insulating layer is formed on the outer surface of the pole teeth which is possible to make contact with the coil winding, the coil winding is not short-circuited through the pole teeth.

In accordance with another embodiment of the present invention, there is provided a stepping motor including a ring-shaped stator core having a plurality of pole teeth erected from an inner circumferential edge portion, and a coil winding wound around the pole teeth. The stator core is covered with an insulating layer on at least the entire surface of the pole teeth and the coil winding is directly wound on the insulating layer around the pole teeth.

According to such a stepping motor, since a coil bobbin for mounting the coil winding is eliminated, the stepping motor can be miniaturized. Also, since the coil winding is directly wound around the pole teeth of the stator core, a thick resin portion is not present between the coil winding and the pole teeth, and thus high magnetic efficiency can be obtained. Further, since the insulating layer is formed on the outer surface of the pole teeth which is possible to make contact with the coil winding, the coil winding is not short-circuited through the pole teeth.

In accordance with an embodiment of the present invention, there is provided another manufacturing method for a stepping motor including a stator core forming step for forming a stator core, a covering step for covering at least the entire surface of the pole teeth of the stator core with an insulating layer, and a coil mounting step for forming a coil winding on the insulating layer around the pole teeth. According to the embodiment, the insulating layer is formed after the stator core is formed. Therefore, even though a burr is formed by means of press working, the burr can be covered over by the insulating layer. Consequently, the coil winding is not short-circuited through the pole teeth.

Preferably, in accordance with an embodiment of the present invention, the entire surface of the stator core may be covered with the insulating layer. In other words, in the manufacturing method for a stepping motor with an embodiment of the present invention, the entire surface of the stator core may be covered with the insulating layer in the covering step.

Preferably, the insulating layer is formed by coating in the covering step. According to such a manufacturing method, the insulating layer for the stator core can be efficiently formed.

Preferably, the terminal pin part where the terminal end of the coil winding is wound around, is formed in such a shape that its tip end side is wider or thicker than its base end side. Also, in the stator core forming step, it is preferable to form the terminal pin part integrally with the stator core, wherein the terminal pin part is formed in such a shape that its tip end side is wider or thicker than its base end side. By this constitution, when the terminal end of the coil winding is wound around the terminal pin part, the terminal end of the coil winding is prevented from slipping off from the tip end side of the terminal pin part.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a cross-sectional view of an essential portion of a PM type stepping motor in accordance with an embodiment of the present invention.

FIG. 2 is explanatory chart and views showing manufacturing steps for a stator in a manufacturing method for the stepping motor shown in FIG. 1.

FIG. 3 is explanatory chart and views showing manufacturing steps for a stator in another manufacturing method for the stepping motor shown in FIG. 1.

FIGS. 4(A) to 4(D) are respectively plan views showing examples of terminal pin parts in a PM type stepping motor in accordance with an embodiment of the present invention.

FIG. 5 is a cross-sectional view of an essential portion of a conventional stepping motor.

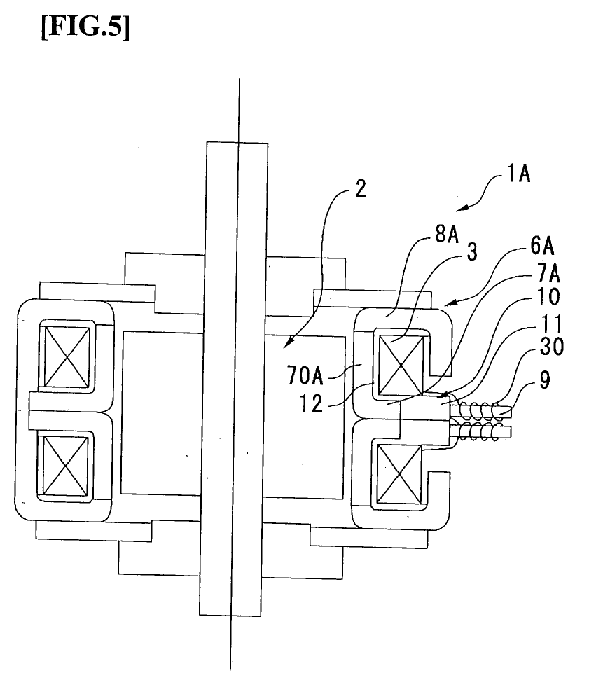

FIG. 6 is explanatory chart and views showing manufacturing steps for a stator in a manufacturing method for a conventional stepping motor.

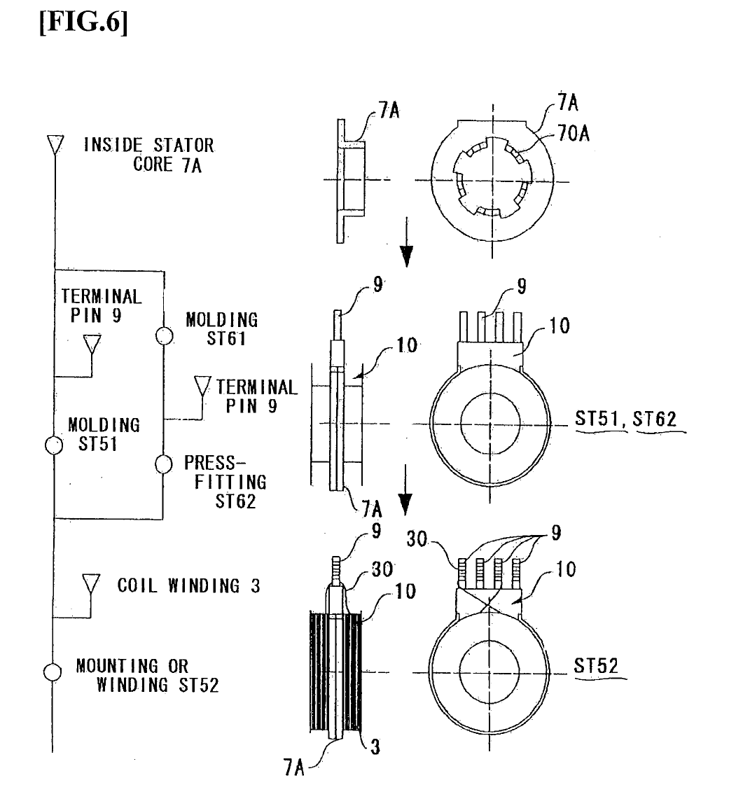

FIG. 7 is explanatory chart and views showing manufacturing steps for a stator in another manufacturing method for a conventional stepping motor.

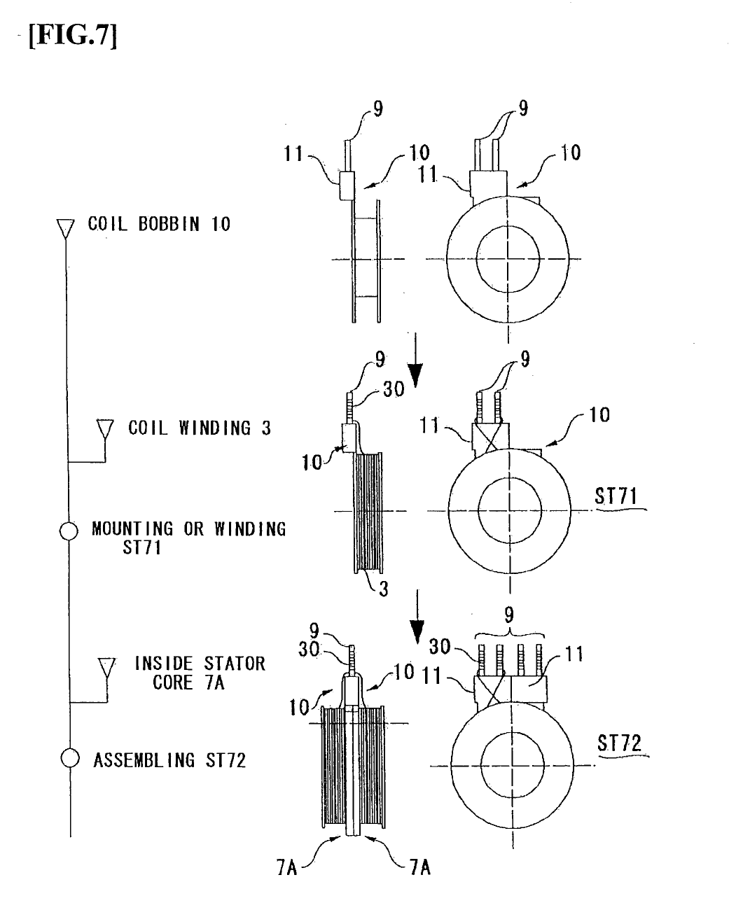

### DETAILED DESCRIPTION OF THE PREFERRED EMBODIMENTS

(Constitution of Stepping Motor)

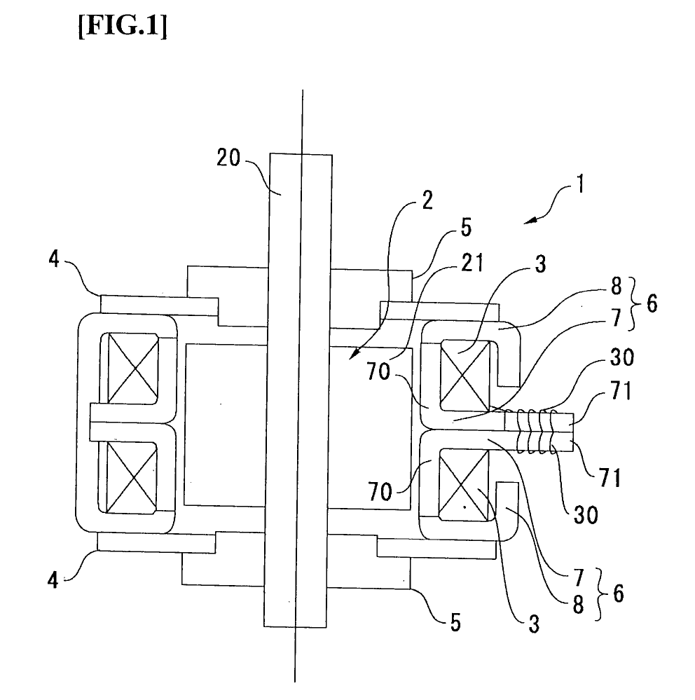

FIG. 1 is a cross-sectional view of an essential portion of a PM type stepping motor in accordance with an embodiment of the present invention.

In FIG. 1, a stepping motor 1 according to an embodiment of the present invention is provided with a rotor 2, a pair of stators 6 adjacently disposed around the rotor 2 so as to oppose each other, and coil windings 3 which are provided with a thin self-welding layer on the surface of the wire of the coil windings 3. An upper end surface and a lower end surface of the stators 6 are respectively covered with side plates 4. A bearing 5 is mounted to the side plate 4 for supporting a rotary shaft 20 of the rotor 2.

A pair of stators 6 are respectively provided with an ring-shaped inside stator core 7 having a plurality of pole teeth 70 formed so as to be erected from an inner circumferential edge portion, and a ring-shaped outside stator core 8 overlaid to the inside stator core 7 in an axis direction. A plurality of pole teeth (not shown) are formed so as to be erected from an inner circumferential edge portion of the outside stator core 8. Each of the pole teeth is alternately positioned between the pole teeth of the inside stator core 7. The pole teeth of the inside stator core 7 and the pole teeth of the outside stator core 8 are respectively opposed to a magnet 21 of the rotor 2.

In the present embodiment, two terminal pin parts 71 are extended so as to be protruded from an outer circumferential edge portion of the inside stator core 7 at a position separated away from each other in a circumferential direction. Two terminal pin parts 71 are integrally protruded from the inside stator core 7 in a radial direction. A terminal end 30 of a coil winding 3 is wound around each of the terminal pin parts 71. The coil winding 3 is wound around directly on the circumferential face of the pole teeth of the inside stator core 7 without a coil bobbin.

In the present embodiment, the entire surface of the inside stator core 7 and the outside stator core 8 are covered with an insulating layer (not shown) by coating.

The entire surface of any portion of the pole teeth 70 such as an outside surface which comes into contact with the coil winding 3, a side edge surface which is possible to make contact with the coil winding 3, and an inside surface which has no possibility of coming into contact with the coil winding 3, is coated and covered with the insulating layer. Therefore, although the coil winding 3 is directly wound around the pole teeth 70, the coil winding 3 is not short-circuited through the pole teeth 70.

The terminal end 30 of the coil winding 3 is soldered on the terminal pin part 71. Although the self-welding layer of the terminal end 30 is removed for electric connection, the entire surface of the terminal pin part 71 is covered with the insulating layer. Therefore, the terminal end 30 of the coil winding 3 is not short-circuited through the terminal pin part 71.

(Manufacturing Method for Stepping Motor 1)

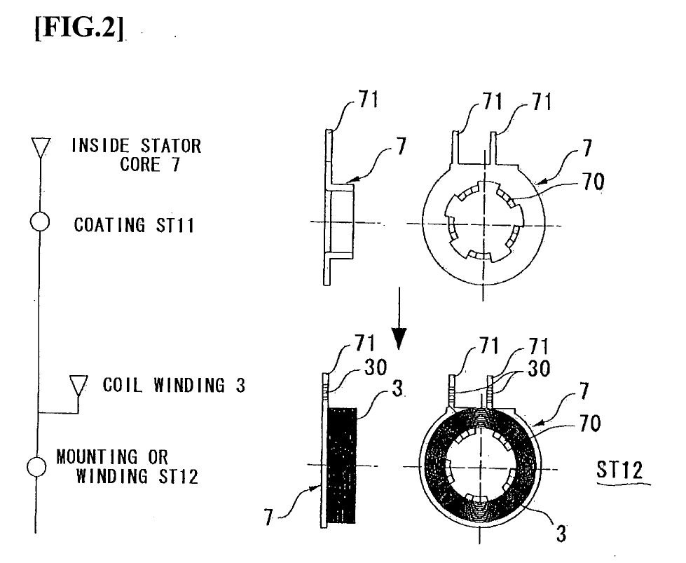

FIG. 2 is a chart and views showing manufacturing steps for the stator 6 in a manufacturing method for the stepping motor 1 shown in FIG. 1.

(Stator Core Forming Step)

In order to form the stator 6 of the stepping motor 1 in accordance with the present embodiment, as shown in FIG. 2, at first, the inside stator core 7 is formed by applying press working to a metal plate such as an iron plate in advance. Simultaneously, two terminal pin parts 71 are formed so as to extend outside from the inside stator core 7 at a position separated away from each other in a circumferential direction.

(Insulating Layer Forming Step)

Next, in a step ST 11, a coating is applied to the entire inside stator core 7 so as to form an insulating layer over the entire surface of the inside stator core 7 including the terminal pin parts 71 and the pole teeth 70

(Coil Mounting Step)

Next, in a step ST 12, the coil winding 3 is wound around the pole teeth 70 on the insulating layer on the inside stator core 7 and the terminal end 30 of the coil winding 3 is wound around the terminal pin part 71 and soldered to the terminal pin part 71.

Then, the outside stator core 8 is overlaid on the inside stator core 7 so as to sandwich the coil winding 3 between the inside stator core 7 and the outside stator core 8 to constitute the stator 6. A coating is applied to the outside stator core 8 to form an insulating layer on the entire surface of the outside stator core 8.

(Another Manufacturing Method for Stepping Motor 1)

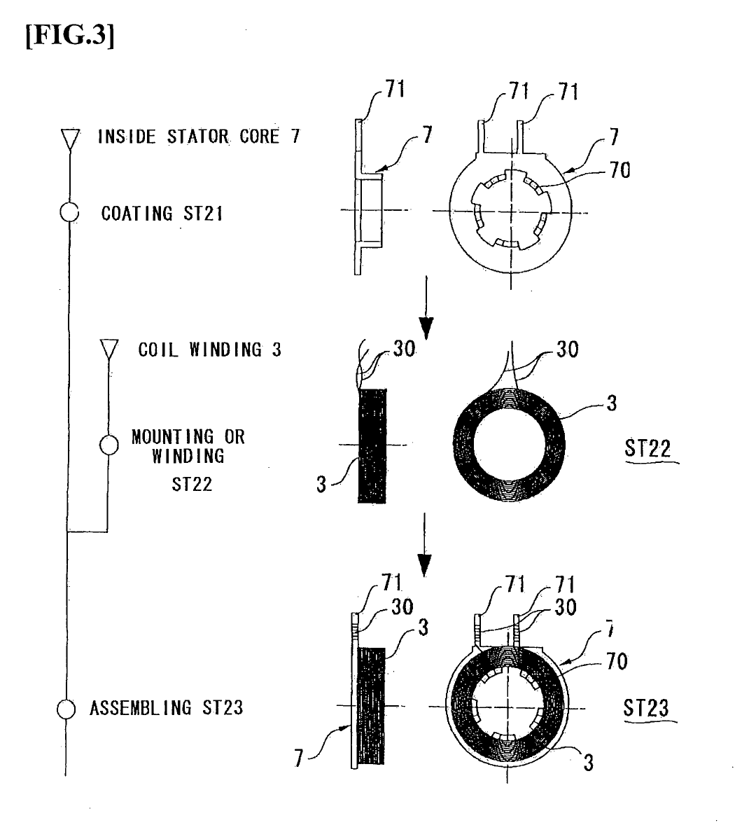

FIG. 3 is a chart and views showing manufacturing steps for the stator 6 in another manufacturing method for the stepping motor 1 shown in FIG. 1.

(Stator Core Forming Step)

In order to form the stator 6 of the stepping motor 1 in accordance with the present embodiment, as shown in FIG. 3, at first, the inside stator core 7 is formed by applying press working to a metal plate such as an iron plate in advance. At this time, two terminal pin parts 71 are simultaneously formed so as to extend outside from the inside stator core 7 at a position separated away from each other in a circumferential direction.

(Insulating Layer Forming Step)

Next, in a step ST 21, a coating is applied to the entire inside stator core 7 to form an insulating layer over the entire surface of the inside stator core 7 including the terminal pin parts 71 and the pole teeth 70.

(Coil Mounting Step)

Separately, in a ST 22, a coil winding 3 is prepared by winding a coil wire beforehand, and the coil winding 3 is fitted around the pole teeth 70 of the inside stator core 7. Next, the terminal end 30 of the coil winding 3 is wound around the terminal pin part 71 and soldered thereto.

(Assembling Step)

Then, in a ST 23, the outside stator core 8 is overlaid on the inside stator core 7 so as to sandwich the coil winding 3 between the inside stator core 7 and the outside stator core 8 to constitute the stator 6. A coating is also applied to the outside stator core 8 to form an insulating layer on the entire surface of the outside stator core 8.

(Effects of the Embodiments)

According to the present embodiment, since the terminal pin parts 71 are formed with the inside stator core 7 in a integral manner, that is, the terminal pin parts 71 are formed by using the inside stator core 7, a coil bobbin having a thick portion for holding conventional terminal pins 71 is unnecessary. Therefore, the stepping motor 1 can be miniaturized. Also, since the surface of the terminal pin part 71 is covered with the insulating layer, the terminal end 30 of the coil winding 3 is not short-circuited through the terminal pin part 71. Moreover, the connection of the terminal pin part 71 and the inside stator core 7 is securely fixed because the terminal pin part 71 is formed integrally with the inside stator core 7. Furthermore, since the terminal end 30 of the coil winding 3 is wound around the terminal pin part 71, the wire of the coil winding 3 is not easily cut, which is different from the conventional case of soldering the terminal end 30 of the coil winding 3 on an electrode pattern formed on the inside stator core. Accordingly, the terminal end of the coil winding 3 can be efficiently handled and treated.

Also, according to the present embodiment, the terminal pin part 71 is integrally punched together with the inside stator core 7 at the outer edge part of the inside stator core 7, and then the insulating layer is formed on the terminal pin part 71. Therefore, the entire surface of the terminal pin part 71 can be coated and covered with the insulating layer, which is different from an imaginative case that an iron plate formed with an insulating layer beforehand is punched by press working to form the terminal pin part 71. Accordingly, the terminal end 30 of the coil winding 3 is not short-circuited through the terminal pin part 71.

Further, though the coil winding 3 is directly wound around the pole teeth 70, the insulating layer is formed on the outside surface and the side edge surfaces of the pole teeth 70 where the coil winding 3 is brought into contact. Therefore, the coil winding 3 is not short-circuited through the pole teeth 70 of the inside stator core 7. Also, since a coil bobbin for winding the coil winding 3 is not provided, a thick resin portion is not present between the coil winding 3 and the pole teeth 70 and thus high magnetic efficiency can be obtained.

According to the present embodiment, the insulating layer is covered after the stator core 7 is formed. Therefore, even though a burr is formed by means of press working, the burr can be covered over by the insulating layer. For this purpose, it is preferable to set a burr being formed within a prescribed size at the time of press working or it is preferable to set the thickness of the insulating layer enough to cover in consideration of the size of the burr. By this constitution, the coil winding is not short-circuited through the pole teeth 70 or the terminal pin part 71.

[Another Embodiments]

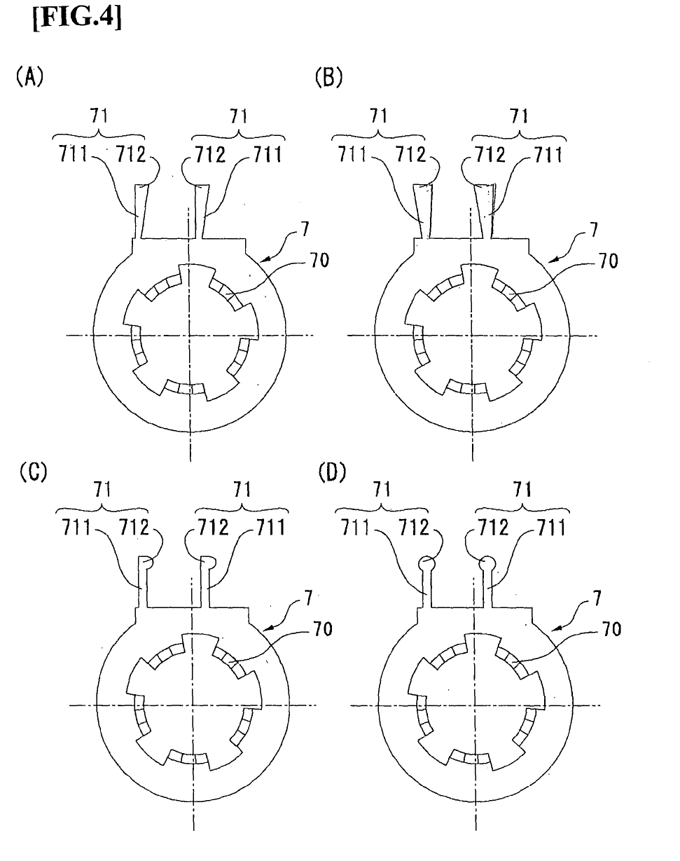

In the above-mentioned embodiments, as shown in FIGS. 2 and 3, the terminal pin part 71 is formed in a straight bar shape, whose thickness and width are equal from the base end portion to the tip end. However, as shown in FIGS. 4(A) to 4(D), it is preferable to employ terminal pin parts 71, which are formed in such a shape that its tip end side 712 is wider or thicker than its base end side 711. By this constitution, when the terminal end of the coil winding is wound around the terminal pin part 71, the terminal end of the coil winding is prevented from slipping off from the tip end side 712 of the terminal pin part 71.

The shape of the terminal pin part 71 whose tip end side 712 is wider or thicker than the base end side 711 can be modified as follows. FIG. 4(A) shows a shape that one of the side faces is slanted towards the tip end side 712 from the base end side 711. FIG. 4(B) shows a shape that both of the side faces are slanted towards the tip end side 712 from the base end side 711. FIG. 4(C) shows a shape that the tip end side 712 is protruded in a semicircular shape. FIG. 4(D) shows a shape that the tip end side 712 is protruded on both sides in a circular shape. In the embodiments having the shape of the terminal pin part 71 whose tip end side 712 is wider than the base end side 711, the terminal pin part 71 can be easily formed by press working.

The embodiments of the present invention are described above. However, needless to say, the present invention is not limited to the embodiments described above, and many modifications can be made without departing from the subject matter of the present invention.

As described above, in the stepping motor according to the present invention, since the terminal pin part is integrally formed with the stator core, a thick resin portion is not needed to provide in the coil bobbin for holding a terminal pin. Accordingly, the size of the stepping motor can be reduced. Also, since the surface of the terminal pin part is covered with the insulating layer, the terminal end of the coil winding is not short-circuited through the terminal pin part. Further, since the terminal pin part is integrally formed with the stator core, the terminal pin part is mounted so that it is firmly fixed to the stator core. Furthermore, since the terminal end of the coil winding is wound around the terminal pin part, the wire of the coil winding is not easily cut, which is different from the case of soldering the terminal end of the coil winding on an electrode pattern formed on the inside stator core. Accordingly, the terminal end of the coil winding can be efficiently handled and treated.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A stepping motor comprising:
a ring-shaped stator core having a plurality of pole teeth erected from an inner circumferential edge portion;
a coil winding wound around the pole teeth; and
a terminal pin part to which a terminal end of the coil winding is wound around,
wherein the terminal pin part is integrally formed and extended from the stator core and an entire surface of at least the terminal pin part of the stator core is covered with an insulating layer.

2. The stepping motor according to claim 1, wherein at least an outer surface of the pole teeth of the stator core is covered with the insulating layer, and the coil winding is directly wound around the insulating layer on the pole teeth.

3. The stepping motor according to claim 1, wherein the entire surface of the stator core is covered with the insulating layer.

4. The stepping motor according to claim 1, wherein the terminal pin part integrally formed with the stator core is formed so that its tip end side is wider or thicker than its base end side.

5. A stepping motor comprising:
a ring-shaped stator core having a plurality of pole teeth erected from an inner circumferential edge portion; and
a coil winding wound around the pole teeth,
wherein the stator core is covered with an insulating layer on at least the entire surface of the pole teeth and the coil winding is directly wound on the insulating layer around the pole teeth.

6. The stepping motor according to claim 5, wherein the entire surface of the stator core is covered with the insulating layer.

7. The stepping motor according to claim 5, further comprising a terminal pin part which is integrally formed with the stator core and is formed so that its tip end side is wider or thicker than its base end side.

8. A manufacturing method for a stepping motor comprising:
forming a stator core and a terminal pin part integrally formed with the stator core;
covering an entire surface of at least the terminal pin part of the stator core with an insulating layer; and
forming a coil winding around pole teeth of the stator core and winding a terminal end of the coil winding around the terminal pin part.

9. The manufacturing method for a stepping motor according to claim 8, further comprising covering at least an outside surface of the pole teeth of the stator core with the insulating layer, and directly winding the coil winding on the insulating layer around the pole teeth.

10. The manufacturing method for a stepping motor according to claim 9, further comprising covering the entire surface of the stator core including the terminal pin part which is integrally formed at an outer edge of the stator core with the insulating layer.

11. The manufacturing method for a stepping motor according to claim 8, further comprising forming the insulating layer by coating.

12. The manufacturing method for a stepping motor according to claim 8, further comprising integrally forming the terminal pin part with the stator core and forming so that its tip end side is wider than its base end side.

13. A manufacturing method for a stepping motor comprising:
forming a stator core;
covering an entire surface of at least pole teeth of the stator core with an insulating layer; and
forming a coil winding directly on the insulating layer around the pole teeth of the stator core.

14. The manufacturing method for a stepping motor according to claim 13, further comprising covering the entire surface of the stator core with the insulating layer.

15. The manufacturing method for a stepping motor according to claim 13, further comprising forming the insulating layer by coating.

16. The manufacturing method for a stepping motor according to claim 13, further comprising integrally forming a terminal pin part with the stator core and forming so that its tip end side is wider than its base end side.

17. The stepping motor according to claim 4, wherein the terminal pin part is formed in a straight bar shape.

18. The stepping motor according to claim 7, wherein the terminal pin part is formed in a straight bar shape.

19. The stepping motor according to claim 4, wherein the terminal pin part includes a side face that is slanted towards the tip end side from the base end side.

20. The stepping motor according to claim 7, wherein the terminal pin part includes a side face that is slanted towards the tip end side from the base end side.
